(19) United States
(12) Patent Application Publication
(10) Pub. No.: US 2010/0025532 A1
(43) Pub. Date: Feb. 4, 2010

(54) SHELL ELEMENT AS PART OF AN AIRCRFAFT FUSELAGE

(75) Inventors: Ralf Herrmann, Ganderkesee (DE); Wolf-Dietrich Dolzinski, Ganderkesee (DE); Hans-Peter Wentzel, Bruchhausen-Vilsen (DE); Michael Kolax, Hamburg (DE)

Correspondence Address: GREER, BURNS & CRAIN, 300 S WACKER DR, 25TH FLOOR, CHICAGO, IL, 60606, US

(73) Assignee: AIRBUS DEUTSCHLAND GMBH, Hamburg (DE)

(21) Appl. No.: 12/520,890

(22) PCT Filed: Jan. 23, 2008
(86) PCT No.: PCT/EP2008/050760

§ 371 Date: Jul. 23, 2009

(30) Foreign Application Priority Data
Jan. 23, 2007 (DE) 102007003275.9

(51) Int. Cl. B64C 1/00

(52) U.S. Cl. 244/120

(57) ABSTRACT

The present invention provides a shell element as part of an aircraft fuselage, wherein the shell element is formed as a curved sheet-like element and is at least partially or completely of CRP construction.

### FIELD OF THE INVENTION

The present invention relates to a shell element, which is used in the construction of an aircraft fuselage and is partially or completely of CRP construction.

### BACKGROUND OF THE INVENTION

The applicant knows that an aircraft fuselage can be produced by joining together a plurality of short fuselage barrels. In this case, the aircraft fuselage is integrated over its circumference. In a further alternative construction, the aircraft fuselage is constructed from fuselage shells. These have the advantage over fuselage barrels of being easier to manufacture and furthermore offering greater flexibility in the design of the fuselage.

Fuselage shells or fuselage barrels of this type, for large civil passenger and transport aircraft, are normally made from metal or a metal alloy. However, these metal fuselage shells or metal fuselage barrels have various drawbacks. In particular, the size of the fuselage shells or fuselage barrels is limited, for example by restrictions imposed by semi-finished products such as metal sheets, limitations in shaping tools or the size of chemical baths that are available for processing. Therefore, if metal fuselage shells are used, it is necessary for a relatively large number of smaller metal shells to be assembled into larger sections and ultimately into the fuselage. A further drawback is that the fuselage shells or fuselage barrels made from metal have a considerable weight.

### SUMMARY OF THE INVENTION

The present invention is therefore based on the object of providing a shell element for an aircraft fuselage which allows simple and inexpensive production of an aircraft fuselage and also permits an additional weight saving.

According to the invention, this object is achieved by a shell element having the features according to Claim 1 and by an aircraft fuselage having the features according to Claim 12, and also by an aircraft having the features according to Claim 14.

A first aspect of the present invention relates to the provision of a shell element for an aircraft fuselage which is formed as a curved sheet-like element and is partially or completely produced as a CRP construction. This has the advantage that the shell element can easily and inexpensively be produced in any desired size. This is particularly advantageous compared to metal shell elements which, as has already been described above in connection with the prior art, are of limited dimensions. A further advantage is that the CRP construction can save weight compared to a metal shell element.

In one embodiment of the invention, at least the outer skin of the shell element is of CRP construction. The outer skin may in this case be formed as or include a laminate. The laminate preferably has one or more layers of a CRP material and may additionally be provided, for example, with at least one layer of a GRP and/or ARP material. The CRP construction of the outer skin has the advantage that considerable weight can be saved as a result compared to a comparable outer skin made from metal as used in the prior art.

In a further embodiment of the invention, the shell element has a length in a range from at least 10 m to 60 m or its length is adapted in such a manner that, in an aircraft, it extends, for example, substantially from behind the cockpit as far as the rear pressure bulkhead.

This has the advantage over the fuselage barrels and fuselage shells that are known from the prior art that a large number of these previous fuselage barrels and fuselage shells which are required to form an aircraft fuselage can be combined in the form of shell elements according to the invention. It is in this way possible to save considerable costs, since there is no need to then join the large number of individual elements. Furthermore, forces can be better absorbed by the shell element according to the invention, since only a small number of shell elements have to be attached to one another in the longitudinal direction to form a fuselage compared, for example, to the known fuselage barrels with their transverse seams. An aircraft fuselage may, for example, be formed from two, three, four or five shell elements, which are integrated over the circumference and are attached to one another in the longitudinal direction.

In another embodiment of the invention, the shell element at least partially or completely is of monolithic CRP construction, hybrid CRP construction and/or sandwich CRP construction. In the case of the sandwich construction, by way of example a core is arranged between two CRP skins. The sandwich construction has the advantage that the shell element has a higher rigidity than in the case of the conventional monolithic construction.

In one embodiment of the invention, in the sandwich structure the core provided may, for example, be a honeycomb structure and/or another suitable reinforcing structure which is composed, for example, of panels and/or profiled sections, which can form suitable supporting structures or struts. This has the advantage of allowing a shell element with a high stability to be formed. The core material used in this case may be fibre-reinforced plastics, such as for example CRP, GRP or ARP, as well as plastic foams, wax paper, such as for example Nomex paper, and/or suitable metal alloys, such as for example aluminum, steel and/or titanium alloys.

In a further embodiment of the invention, the structure of the shell element can be varied in the longitudinal and/or width direction, for example in terms of its strength, rigidity, its thickness, its fibre orientation in the case of fibre-reinforced materials such as CRP, ARP or GRP and/or its material or materials. The structure of the shell element is in this case varied, for example, in respect of differing thicknesses etc. preferably on the side of the shell element facing towards the cabin. A shell element of this type has the advantage that it can be adapted to a very wide range of loads which can occur in different regions of the shell element. For example, the shell element can be reinforced in regions in which particularly high stresses occur, for example in the region where the wings meet the body. A further advantage is that the shell elements are easily accessible compared to fuselage barrels for example if individual regions need to be of increased thickness, since the outer side of the shell element lies in a mould whereas the inner side, which faces the aircraft interior, is uncovered and thus can be individually worked on. If fuselage barrels made from CRP materials were to be produced instead of the shell elements, they would have to be provided with a core to which the CRP material is applied. Consequently, a variation for example in the material thickness would have to be correspondingly incorporated in the core in order to prevent the fuselage barrels from subsequently having a non uniform structure on their outer sides. However, this involves considerable work and additional costs.

In a further embodiment of the invention, the shell element may either be directly provided with cut-outs, for example for windows or doors, or these cut-outs can subsequently be cut out of the shell element, for example by laser means. Subsequent cutting of the cut-outs out of the shell element has the advantage of being particularly inexpensive in terms of production.

Further aspects of the present invention relate to an aircraft fuselage which is constructed from the shell elements according to the invention and an aircraft having an aircraft fuselage of this type.

### BRIEF DESCRIPTION OF THE DRAWINGS

The invention is explained in more detail below on the basis of exemplary embodiments and with reference to the accompanying figures, in which:

FIG. 1 shows a perspective, diagrammatic view of a shell construction using metal shells; and

FIG. 2 shows a perspective diagrammatic view of an aircraft with a fuselage made up of shell elements according to the invention.

### DETAILED DESCRIPTION OF THE DRAWINGS

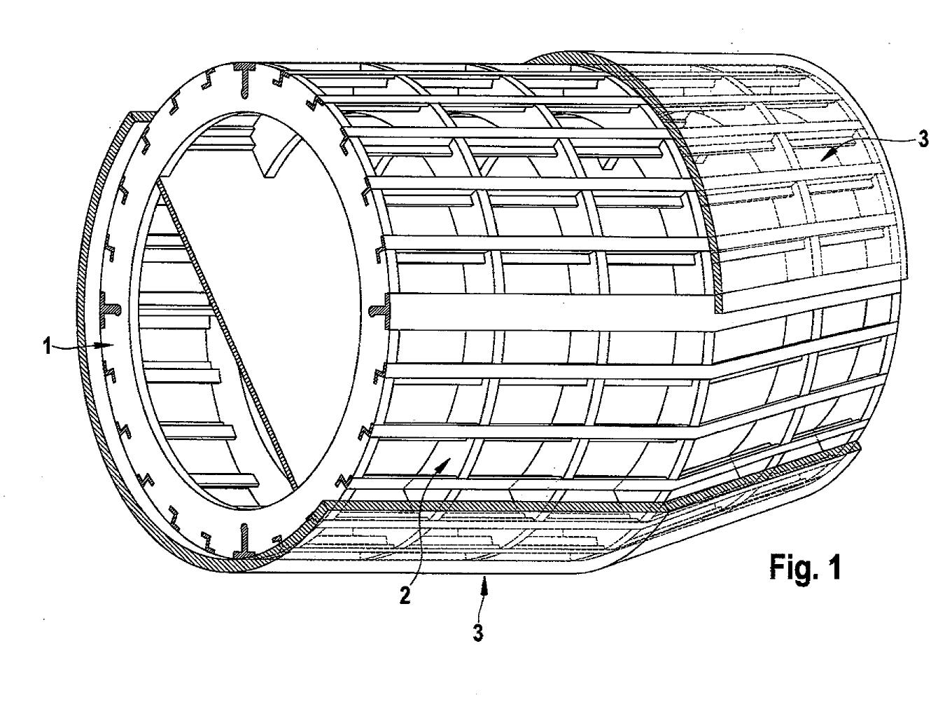

FIG. 1 diagrammatically depicts a fuselage construction of monocoque construction, wherein metal panelling parts 3 are attached to a grid of frames 2. Here, relatively large numbers of smaller metal shells have to be attached to the frame grid and a plurality of such fuselage barrels 1 have to be subsequently assembled to form a fuselage, with the fuselage barrels 1 being attached to one another via transverse joints.

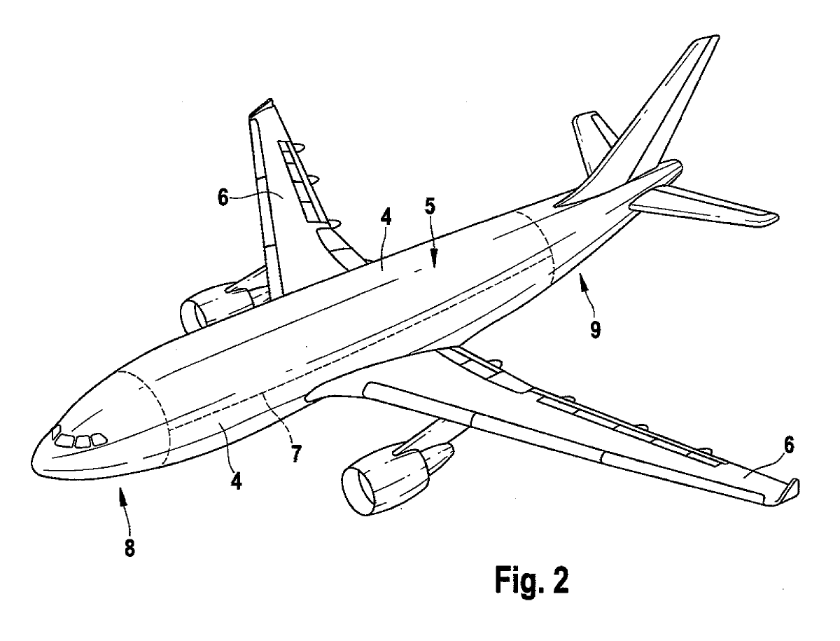

By contrast, the aircraft fuselage according to the invention is formed from at least two long shell elements 4, as illustrated in greatly simplified form in FIG. 2, wherein the position of the shell elements 4 so as to construct the fuselage is likewise only diagrammatically indicated. The number and position of the shell elements 4 can be varied as desired for example according to function, aircraft type, etc., and is not restricted to the highly simplified illustration in FIG. 2.

The shell elements 4 are of CRP construction and can be joined to one another in the longitudinal direction for example conventionally by means of rivets (not shown), to mention just one of numerous possible attachment options. The CRP construction has the advantage over metal shell elements that the shell elements 4 can in principle be produced in any desired dimensions or sizes, since CRP materials can be purchased and used as an endless semi-finished product, as it were.

Numerous processes for manufacturing CRP composite parts are generally known. Therefore, just a few examples of such processes will be mentioned below. In the autoclave process, the process of curing the resin-impregnated mat (for example prepregs) takes place in the autoclave. Standard prepregs have a resin content of approx. 40%. If honeycombs are used, so-called adhesive prepregs (increased resin content) are used as a direct connection to the honeycomb, in order to ensure wetting of the honeycomb without depletion of the laminate. A further process is resin transfer moulding (RTM). This is a resin injection process. Also known is the single-line injection (SLI) process. In the SLI process, unlike the conventional RTM process which uses two mould halves, the forces for compacting the fibre material are not applied mechanically by a huge tool, but rather via a relatively flexible mould half using autoclave pressure. Also known is the lamination process, which involves providing a mould which forms the subsequent component surface and alternately applying thin resin layers to fibre mats. A process of this type is suitable in particular for producing the shell elements according to the invention. Also known is the fibre spraying process, which uses a fibre spray gun. In this process, resin, curative, accelerator and long fibres are mixed and applied to a mould. This process can likewise be used to produce the shell elements according to the invention. Cold pressing or hot pressing are also generally known. In this case, prepregs or fibre-reinforced resin moulding compounds are pressed either cold or at elevated temperature to form components.

The production of the shell element 4 according to the invention is not restricted to one specific process or one specific construction. For example, in addition to a monolithic construction the shell element 4 may also have a CRP/metal hybrid construction. In this case, the fuselage skin may consist of a CRP material and stringers and/or frames may consist of metal or a metal alloy. If the stringers or frames are made from a metal or a metal alloy which leads to galvanic corrosion on contact with CRP and an electrolyte, suitable protective measures must be taken to prevent corrosion, for example the use of glass fibre mats or tedlar sheets between CRP components and metal components and the use of suitable attachment means, which are made for example from nonconductive material or are encapsulated with GRP or the shank of which is provided with a sleeve made from a nonconductive material.

The shell element 4 may optionally also have a sandwich construction, in which, for example, at least one core is inserted between two CRP skins (not shown) or between two CRP laminates. The core (not shown) may in this case for example have a honeycomb structure or a foamed structure or for example be assembled from panels and/or profiled sections. The core material may in this case consist of at least one fibre-reinforced plastic, such as for example CRP, GRP and/or ARP, a plastic foam, wax paper, such as for example Nomex paper, and/or a metal alloy, such as for example an aluminium, steel and/or titanium alloy.

The structure of the shell element 4 can also be varied in the longitudinal and/or width direction. This has the advantage that areas or regions of the shell element 4 can be individually adapted to the loads that are acting there. Normally, not all regions of an aircraft fuselage are exposed to identical loads or loads of the same magnitude; for example, the region of the fuselage 5 which meets the wings 6 and the rear region of the fuselage 5 are more heavily loaded than other regions of the aircraft fuselage. To correspondingly adapt the shell element 4, the shell element 4 may, for example, be formed with regions of differing thickness, depending on the magnitude or type of loading or the forces which are active. Furthermore, if fibre-reinforced materials are used, their fibre orientation can be varied in different regions of the shell element 4, for example as a function of the loads and forces that occur there. Furthermore, it is also conceivable to vary the material, so that different materials can be used or combined with one another in regions of the shell element 4. By way of example, it is conceivable to use particularly stable or load-resistant materials in regions that are exposed to particularly high levels of load, whereas other, less load-resistant materials can be used in other regions that are less highly loaded. It is in this way also possible to suitably adapt the strength and/or rigidity of individual regions of the shell element 4.

The variation in the structure of the shell element 4 can be realized not only to take account of forces and loads that occur but also as a function of numerous other factors, including weight saving and economic factors. One advantage here is that the outer side of the shell element 4 can be held in a mould or holder (not shown) while the inner side is exposed and therefore readily accessible. It is in this way possible, for example, for fibre-reinforced material to very easily be applied in different fibre directions and thicknesses to the shell element 4 without, for example, having to previously incorporate thickness changes in a core that is subsequently surrounded by the fibre-reinforced material. Furthermore, it is also possible to use different cores which vary in terms of material and/or construction in a sandwich construction. Cores of this type can easily be used on the shell element 4, since the shell element 4 is completely accessible from its inner side, unlike the described ring elements with a core.

The technology according to the invention of very long fibre-reinforced fuselage shells 4 can reduce the number of shells required, with corresponding joins, by approx. 80% compared to current metal technology. The long shell elements 4 have the advantage that their joining via longitudinal seams 7 allows better transfer of load than transverse seams as occur when joining fuselage barrels. In principle, the great length of the shell elements 4 according to the invention alone allows better load transfer to be achieved, since very many fewer seams and transitions are present compared to a multiplicity of fuselage barrels which have to be joined to one another in order to form the fuselage and consequently have a large number of transverse seams and form a large number of transitions.

The shell elements 4 according to the invention can be produced in any desired dimensions. For example, the shell element 4 may have any length, width and thickness. In particular, the shell element 4 may, for example, have a length of 10-15 m or of 10 m to 20 m, of 20 m to 25 m, or of 20 m to 30 m, of 30 m to 35 m or of 30 m to 40 m, of 40 m to 45 m or of 40 m to 50 m, of 50 m to 55 m or of 50 m to 60 m and greater. All intermediate values within these ranges are also included. In principle, the length of the shell element 4 may also be less than 10 m.

The specific length of the shell element 4 is dependent on the particular aircraft and is individually defined. The same is also true of the width and thickness of the shell elements 4. The shell element 4 according to the invention may, for example, extend from behind the cockpit 8 as far as the rear pressure bulkhead 9 and a fuselage may, for example, be made up over its circumference of 2, 3, 4, 5 or more shell elements 4.

According to the prior art, as illustrated for example in FIG. 1, depending on the aircraft there are 4, 5 or more transverse joints or transverse seams between the tubular fuselage sections, which had initially been assembled from smaller shells. By contrast, the invention can reduce the number of transverse joints in the typical fuselage region to 0 or 1 in the case of extremely long aircraft. The nose and tail can remain as separate parts and be joined to the fuselage.

The invention provides an aircraft fuselage of fibre composite or hybrid, integral construction, in which the number of shell elements that has hitherto been required is minimized by the fact that the extent and function of these elements can be combined in a small number of now very long and single-part fuselage shells 4, so that the number of transverse joints required can be reduced.

The CRP construction and the reduction in the number of joins allows considerable weight to be saved and the production costs to be reduced. Integration is one of the ways of controlling costs of the CRP construction to make it economic. The invention makes it easier to achieve economic objectives with pure CRP constructions and hybrid constructions, in which, for example, the fuselage panelling is constructed from a CRP material and frames and/or stringers are made from metal or a metal alloy.

The invention provides a single component, in this case the shell element 4, where previously a large number of components had to be used. This also eliminates the joins that were previously required. This in turn considerably relieves the manufacturing processes and simplifies logistics and process control. The range of production means and manufacturing equipment can be reduced and simplified. Furthermore, it is possible to achieve simplifications in the assembly and fitting through the drastic reduction in the number of components. In detail, the size of the components also involves procedural changes which, however, are in no way a compensatory factor. Compared to a construction for example of CRP fuselage barrels, it is possible to significantly minimize manufacturing risk and to achieve a higher flexibility in change of design and/or materials.

Furthermore, the fuselage structure according to the invention and the shell element 4 according to the invention allow weight savings, cost savings and accelerations in throughput times compared to the previous shell split.

Compared to the production of CRP fuselage barrels, in addition to the advantage of reduced production risk, there is the further advantage that less outlay is required on production means and equipment and, moreover, the learning curves are more favourable. Further technical developments, local design changes, learning effects, alternative materials are also much easier to implement, since, for example, there is no need to provide a core to which the CRP material is applied in order to form a fuselage barrel. Fuselage barrels of this type are produced, for example, by a winding process, in which reinforcing fibres are wound around a rotating core, which disadvantageously, depending on the geometry, remains in the component or is removed from it again.

Although the present invention has been described above on the basis of preferred exemplary embodiments, it is not restricted thereto, but rather can be modified in numerous ways.

1. A shell element as part of an aircraft fuselage, wherein the shell element is formed as a curved sheet-like element and is at least partially or completely of CRP construction, wherein at least the thickness of the shell element is variable over the width and/or length of the shell element on the side of the shell element facing towards the cabin, wherein the shell element has a length in a range from at least 10 m to 60 m and wherein the shell element is manufactured by a lamination process or by a fibre spraying process.

2. The shell element according to claim 1, wherein at least the outer skin of the shell element is produced completely as a CRP construction.

3. The shell element according to claim 1, wherein the shell element has a length in a range from at least 35 m to 60 m.

4. The shell element according to claim 1, wherein the length of the shell element is adapted in such a manner that in an aircraft it extends starting from behind the cockpit as far as the rear pressure bulkhead or at least in a region therebetween.

5. The shell element according to claim 1, wherein the shell element at least partially is of monolithic CRP construction and/or hybrid CRP construction.

6. The shell element according to claim 1, wherein the shell element at least partially is of sandwich CRP construction.

7. The shell element according to claim 6, wherein in the sandwich CRP construction a core is arranged between two CRP skins.

8. The shell element according to claim 7, wherein the core has a honeycomb structure or another suitable reinforcing structure which is composed of panels and/or profiled sections.

9. The shell element according to claim 8, wherein the core includes a fibre-reinforced plastic, such as for example CRP, GRP or ARP, a plastic foam, wax paper, such as for example Nomex paper, and/or a metal alloy, such as for example an aluminium, steel and/or titanium alloy.

10. The shell element according to claim 1, wherein at least the thickness, the fibre orientation, the strength, the rigidity and/or the material of the shell element is variable over the width and/or length of the shell element, for example on the side of the shell element facing towards the cabin.

11. The shell element according to claim 1 wherein cut-outs, for example for windows or doors, are provided in the shell element, for example are shaped out or can be cut out by laser means.

12. An aircraft fuselage, the circumference of which is at least partially formed from shell elements according to claim 1.

13. The aircraft fuselage according to claim 12, wherein the circumference of the aircraft fuselage is formed from, for example, two, three, four or five shell elements.

14. The aircraft having an aircraft fuselage according to claim 12.
